(19) United States
(12) Patent Application Publication
(10) Pub. No.: US 2005/0118478 A1
(43) Pub. Date: Jun. 2, 2005

(54) Mixture comprising sulphonic acid containing vinyl, polymer electrolyte membrane comprising polyvinylsulphonic acid and the use thereof in fuel cells

(76) Inventors: Joachim Kiefer, Losheim am See (DE); Oemer Uensal, Mainz (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/506,622

(22) PCT Filed: Mar. 4, 2003
(86) PCT No.: PCT/EP03/02395

(30) Foreign Application Priority Data
Mar. 6, 2002 (DE) 102 09 684.8
Mar. 11, 2002 (DE) 102 01 500.6

(51) Int. Cl. H01M 8/10; C08J 5/22

(52) U.S. Cl. 429/33; 521/27

(57) ABSTRACT

The present invention relates to a proton-conducting polymer membrane which is based on polyvinylsulphonic acid and is obtainable by a process comprising the steps A) mixing of a polymer with vinyl-containing sulphonic acid, B) formation of a flat structure using the mixture from step A) on a support, C) polymerization of the vinylsulphonic acid present in the flat structure from step B). Owing to its excellent chemical and thermal properties, a membrane according to the invention can be used in a wide variety of applications and is particularly useful as polymer electrolyte membrane (PEM) in PEM fuel cells.

The present invention relates to a mixture comprising vinylsulphonic acid monomers and a proton-conducting polymer electrolyte membrane based on polyvinylsulphonic acid which, owing to its excellent chemical and thermal properties, can be used in a variety of applications and is particularly useful as polymer electrolyte membrane (PEM) in PEM fuel cells.

A fuel cell usually comprises an electrolyte and two electrodes separated by the electrolyte. In the case of a fuel cell, one of the two electrodes is supplied with a fuel such as hydrogen gas or a methanol/water mixture and the other electrode is supplied with an oxidant such as oxygen gas or air and chemical energy from the oxidation of the fuel is thus converted directly into electric energy. The oxidation reaction forms protons and electrons.

The electrolyte is permeable to hydrogen ions, i.e. protons, but not to reactive fuels such as the hydrogen gas or methanol and the oxygen gas.

A fuel cell generally comprises a plurality of single cells known as MEUs (membrane electrode units) which each comprise an electrolyte and two electrodes separated by the electrolyte.

Electrolytes employed for the fuel cell are solids such as polymer electrolyte membranes or liquids such as phosphoric acid. Polymer electrolyte membranes have recently attracted particular attention as electrolytes for fuel cells. An in-principle distinction may be made between two categories of polymer membranes.

The first category encompasses cation-exchange membranes composed of a polymer framework containing covalently bound acid groups, preferably sulphonic acid groups. The sulphonic acid group is converted into an anion with release of a hydrogen ion and therefore conducts protons. The mobility of the proton and thus the proton conductivity is directly related to the water content. Due to the very good miscibility of methanol and water, such cation-exchange membranes have a high methanol permeability and are therefore unsuitable for use in a direct methanol fuel cell. If the membrane dries out, i.e. as a consequence of a high temperature, the conductivity of the membrane and therefore the performance of the fuel cell decreases drastically. The operating temperatures of fuel cells containing such cation-exchange membranes is thus limited to the boiling point of water. The moistening of the fuels is an important technical requirement for the use of polymer electrolyte membrane fuel cells (PEMFCs) in which conventional, sulphonated membranes, e.g. Nafion, are used.

Thus, perfluorosulphonic acid polymers, for example, are used as materials for polymer electrolyte membranes. The perfluorosulphonic acid polymer (e.g. Nafion) generally has a perfluorocarbon skeleton, e.g. a copolymer of tetrafluoroethylene and trifluorovinyl, and, bound thereto, a side chain bearing a sulphonic acid group, e.g. a side chain having a sulphonic acid group bound to a perfluoroalkylene group.

The cation-exchange membranes are preferably organic polymers having covalently bound acid groups, in particular sulphonic acid. Processes for sulphonating polymers are described in F. Kucera et al. Polymer Engineering and Science 1988, Vol. 38, No 5, 783-792.

In the following, the most important types of cation-exchange membranes which have achieved commercial importance for use in fuel cells are described.

The most important representative is the perfluorosulphonic acid polymer Nafion® (U.S. Pat. No. 3,692,569). This polymer can, as described in U.S. Pat. No. 4,453,991, be brought into solution and then used as ionomer. Cation-exchange membranes are also obtained by filling a porous support material with such an ionomer. As support material, preference is given here to expanded Teflon (U.S. Pat. No. 5,635,041). A further perfluorinated cation-exchange membrane can, as described in U.S. Pat. No. 5,422,411, be prepared by copolymerization of trifluorostyrene and sulphonyl-modified trifluorostyrene. Composite membranes comprising a porous support material, in particular expanded Teflon, filled with ionomers comprising such sulphonyl-modified trifluorostyrene copolymers are described in U.S. Pat. No. 5,834,523.

U.S. Pat. No. 6,110,616 describes copolymers of butadiene and styrene and their subsequent sulphonation to prepare cation-exchange membranes for fuel cells.

A further class of partially fluorinated cation-exchange membranes can be prepared by radiation grafting and subsequent sulphonation. Here, as described in EP667983 or DE1 9844645, a grafting reaction, preferably with styrene, is carried out on a previously irradiated polymer film. In a subsequent sulphonation reaction, the side chains are then sulphonated. Crosslinking can also carried out simultaneously with the grafting reaction so as to alter the mechanical properties.

Apart from the above membranes, a further class of unfluorinated membranes obtained by sulphonation of high-temperature-stable thermoplastics has been developed. Thus, membranes made of sulphonated polyether ketones (DE4219077, EP96/01177), sulphonated polysulphone (J. Membr. Sci. 83 (1993) p. 211) or sulphonated polyphenylene sulphide (DE19527435) are known. Ionomers prepared from sulphonated polyether ketones are described in WO 00/15691.

Also known are acid-based blend membranes which, as described in DE19817374 or WO 01/18894, are prepared by mixing sulphonated polymers and basic polymers.

To improve the membrane properties further, a cation-exchange membrane known from the prior art can be mixed with a high-temperature-stable polymer. The preparation and properties of cation-exchange membranes comprising blends of sulphonated PEK and a) polysulphones (DE4422158), b) aromatic polyamides (42445264) or c) polybenzimidazole (DE19851498) have been described.

A disadvantage of all these cation-exchange membranes is the fact that the membrane has to be moistened, the operating temperature is restricted to 100° C. and the membranes have a high methanol permeability. The reason for these disadvantages is the conductivity mechanism of the membrane in which the transport of protons is coupled with the transport of the water molecule. This is referred to as the “vehicle mechanism” (K.-D. Kreuer, Chem. Mater. 1996, 8, 610-641).

As a second category, polymer electrolyte membranes comprising complexes of basic polymers and strong acids have been developed. Thus, WO96/13872 and the corresponding U.S. Pat. No. 5,525,436 describe a process for preparing a proton-conducting polymer electrolyte membrane in which a basic polymer such as polybenzimidazole is treated with a strong acid such as phosphoric acid, sulphuric acid, etc.

J. Electrochem. Soc., Volume 142, No. 7,1995, pp. L121-L123, describes the doping of a polybenzimidazole in phosphoric acid.

In the case of the basic polymer membranes known from the prior art, the mineral acid used to achieve the necessary proton conductivity (usually concentrated phosphoric acid) is either introduced after shaping or, as an alternative, the basic polymer membrane is prepared directly from polyphosphoric acid as in the German patent applications no. 10117686.4, no. 10144815.5 and no. 10117687.2. The polymer serves as support for the electrolyte comprising the highly concentrated phosphoric acid or polyphosphoric acid. The polymer membrane here performs further essential functions; in particular, it has to have a high mechanical stability and serve as separator for the two fuels mentioned at the outset.

An important advantage of such a membrane doped with phosphoric acid or polyphosphoric acid is the fact that a fuel cell in which such a polymer electrolyte membrane is used can be operated at temperatures about 100° C. without moistening of the fuels as is otherwise necessary. This is due the ability of the phosphoric acid to transport protons without additional water by means of the Grotthus mechanism (K.-D. Kreuer, Chem. Mater. 1996, 8, 610-641).

The ability of the fuel cell to be operated at temperatures above 100° C. results in further advantages for the fuel cell system. Firstly, the sensitivity of the Pt catalyst to impurities in the gas, in particular CO, is greatly reduced. CO is formed as by-product in the reforming of the hydrogen-rich gas from carbon-containing compounds, e.g. natural gas, methanol or petroleum spirit, or as intermediate in the direct oxidation of methanol. The CO content of the fuel at temperatures of <100° C. typically has to be less than 100 ppm. However, in the case of temperatures in the range 150-200° C., 10 000 ppm or more of CO can be tolerated (N. J. Bjerrum et al. Journal of Applied Electrochemistry, 2001, 31, 773-779). This leads to substantial simplification of the preceding reforming process and thus to cost reductions for the overall fuel cell system.

A great advantage of fuel cells is the fact that the energy of the fuel is converted directly into electric energy and heat in the electrochemical reaction. Water is formed as reaction product at the cathode. Heat is also evolved as by-product of the electrochemical reaction. In the case of applications in which only the electric power is utilized for driving electric motors, e.g. for automobile applications, or in a variety of replacements for battery systems, the heat has to be removed in order to avoid overheating of the system. Additional energy-consuming equipment then becomes necessary for cooling and this reduces the overall electrically efficiency of these fuel cells further. In the case of stationary applications as in the centralized or decentralized generation of power and heat, the heat can be utilized efficiently by means of existing technologies such as heat exchangers. To increase the efficiency, high temperatures are sought. If the operating temperature is above 100° C. and the temperature difference between the ambient temperature and the operating temperature is large, it becomes possible to cool the fuel cell system more efficiently or to use small cooling areas and to dispense with additional equipment compared to fuel cells which, owing to the need to moisten the membrane, have to be operated at below 100° C.

Besides these advantages, such a fuel cell system has a critical disadvantage, namely the fact that phosphoric acid or polyphosphoric acid is present as an electrolyte which is not bound permanently to the basic polymer as a result of ionic interactions and can be washed out by water. Water is, as described above, formed in the electrochemical reaction at the cathode. If the operating temperature is above 100° C., most of the water is discharged as vapour through the gas diffusion electrode and the loss of acid is small. However, if the operating temperature is below 100° C., e.g. during running up and running down of the cell or in part load operation when a high current yield is sought, the water formed condenses and can lead to increased leaching of the electrolyte, viz. highly concentrated phosphoric acid or polyphosphoric acid. In the above-described mode of operation of the fuel cell, this can lead to a continual decrease in the efficiency and cell power, which can reduce the life of the fuel cell.

Furthermore, the known membranes doped with phosphoric acid cannot be used in the direct methanol fuel cell (DMFC). However, such cells are of particular interest since a methanol/water mixture is used as fuel. If a known membrane based on phosphoric acid is used, the fuel cell fails after quite a short time.

It is therefore an object of the present invention to provide a new type of polymer electrolyte membrane in which leaching of the electrolyte is prevented. A fuel cell comprising a polymer electrolyte membrane according to the invention should be suitable for use with pure hydrogen and also numerous carbon-containing fuels, in particular natural gas, petroleum spirit, methanol and biomass.

Furthermore, a membrane according to the invention should be able to be produced inexpensively and simply. In addition, it is an object of the present invention to create polymer electrolyte membranes which display high performance, in particular a high conductivity.

Furthermore, a polymer electrolyte membrane which has a high mechanical stability, for example a high modulus of elasticity, a high tear strength, low creep and a high fracture toughness, should be provided.

In addition, it is an object of the present invention to provide a membrane which, in operation too, has a low permeability to a wide of variety of fuels, for example hydrogen or methanol, and this membrane should also display a low oxygen permeability.

These objects are achieved by the preparation of a mixture comprising vinyl-containing phosphoric acid and a polymer electrolyte membrane obtainable from this mixture and a further polymer.

A polymer electrolyte membrane according to the invention has a very low methanol permeability and is therefore particularly suitable for use in a DMFC. Long-term operation of a fuel cell using many fuels such as hydrogen, natural gas, petroleum spirit, methanol or biomass is thus possible. The membranes make a particularly high activity of these fuels possible. Due to the high temperatures, the oxidation of methanol can occur with high activity.

In addition, membranes of the present invention display a high mechanical stability, in particular a high modulus of elasticity, a high tear strength, low creep and a high fracture toughness. Furthermore, these membranes display a surprisingly long life.

The present invention provides a proton-conducting polymer membrane which is based on pblyvinylsulphonic acid and is obtainable by a process comprising the steps
A) mixing of a polymer with vinyl-containing sulphonic acid,
B) formation of a flat structure using the mixture from step A) on a support,
C) polymerization of the vinyl-containing sulphonic acid present in the flat structure from step B).

The polymers used in step A) are one or more polymers which have a solubility of at least 1% by weight, preferably at least 3% by weight, in the vinyl-containing sulphonic acid, with the solubility being dependent on the temperature. However, the mixture used to form the flat structure can be obtained in a wide temperature range, so that only the required minimum solubility has to be achieved. The lower limit to the temperature is determined by the melting point of the liquid present in the mixture, with the upper temperature limit generally being determined by the decomposition temperatures of the polymers or the constituents of the mixture. In general, the mixture is prepared in a temperature range from 0° C. to 250° C., preferably from 10° C. to 200° C. In addition, an elevated pressure can be used for dissolution, with the limits to this being determined by the technical circumstances. The polymer used in step A) is particularly preferably a polymer which has a solubility of at least 1% by weight in vinyl-containing sulphonic acid at 160° C. and 1 bar.

Preferred polymers include, inter alia, polyolefins such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidone, polyvinylpyridine, polyvinyl chloride, polyvinylidene chloride, polytetrafluoroethylene, polyhexafluoropropylene, copolymers of PTFE with hexafluoropropylene, with perfluoropropyl vinyl ether, with trifluoronitrosomethane, with carbalkoxy perfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornene;
polymers having C—O bonds in the main chain, for example polyacetal, polyoxymethylene, polyethers, polypropylene oxide, polyepichlorhydrin, polytetrahydrofuran, polyphenylene oxide, polyether ketone, polyesters, in particular polyhydroxyacetic acid, polyethylene terephthalate, polybutylene terephthalate, polyhydroxybenzoate, polyhydroxypropionic acid, polypivalolactone, polycaprolactone, polymalonic acid, polycarbonate;
polymers having C—S bonds in the main chain, for example polysulphide ethers, polyphenylene sulphide, polyether sulphone;
polymers having C—N bonds in the main chain, for example polyimines, polyisocyanides, polyetherimine, polyetherimides, polyaniline, polyaramides, polyamides, polyhydrazides, polyurethanes, polyimides, polyazoles, polyazole ether ketone, polyazines;
liquid-crystalline polymers, in particular Vectra and inorganic polymers for example polysilanes, polycarbosilanes, polysiloxanes, polysilicic acid, polysilicates, silicones, polyphosphazenes and polythiazyl.

According to a particular aspect of the present invention, high-temperature-stable polymers containing at least one nitrogen, oxygen and/or sulphur atom in one repeating unit or in different repeating units are used.

For the purposes of the present invention, a high-temperature-stable polymer is a polymer which can be operated long-term as polymer electrolyte in a fuel cell at temperatures above 120° C. “Long-term” means that a membrane according to the invention can be operated for at least 100 hours, preferably at least 500 hours, at at least 120° C., preferably at least 160° C., without the power, which can be measured by the method described in WO 01/18894 A2, decreasing by more than 50%, based on the initial power.

The polymers used in step A) are preferably polymers which have a glass transition temperature or Vicat softening temperature VSTIA/50 of at least 100° C., preferably at least 150° C. and very particularly preferably at least 180° C.

Particular preference is given to polymers which contain at least one nitrogen atom in a repeating unit. Very particular preference is given to polymers which contain at least one aromatic ring containing at least one nitrogen heteroatom per repeating unit. Within this group, very particular preference is given to polymers based on polyazoles. These basic polyazole polymers contain at least one aromatic ring containing at least one nitrogen heteroatom per repeating unit.

The aromatic ring is preferably a five- or six-membered ring which has from one to three nitrogen atoms and may be fused with another ring, in particular another aromatic ring.

Polyazole-based polymers comprise recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII) 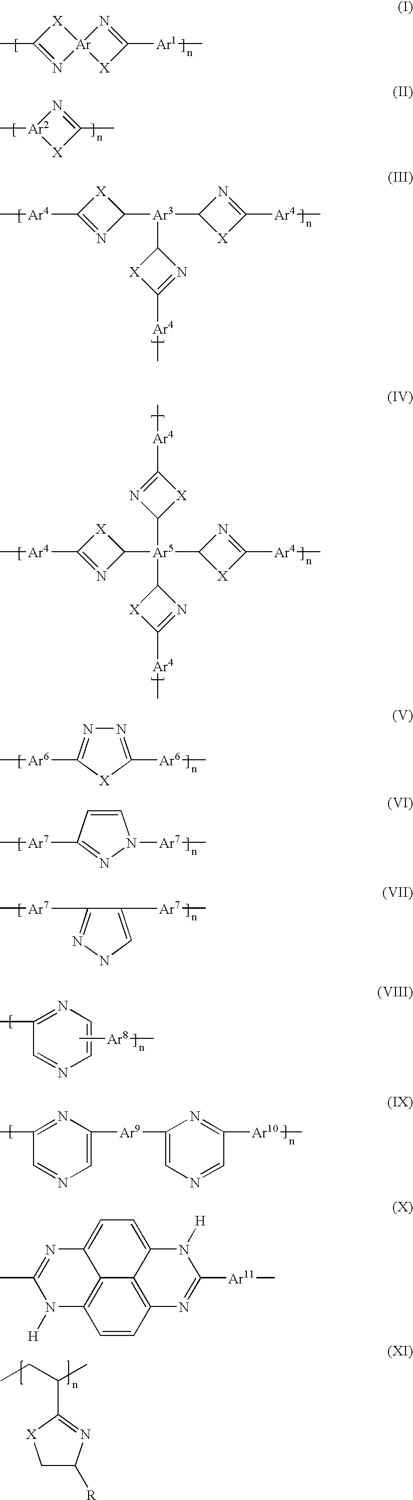 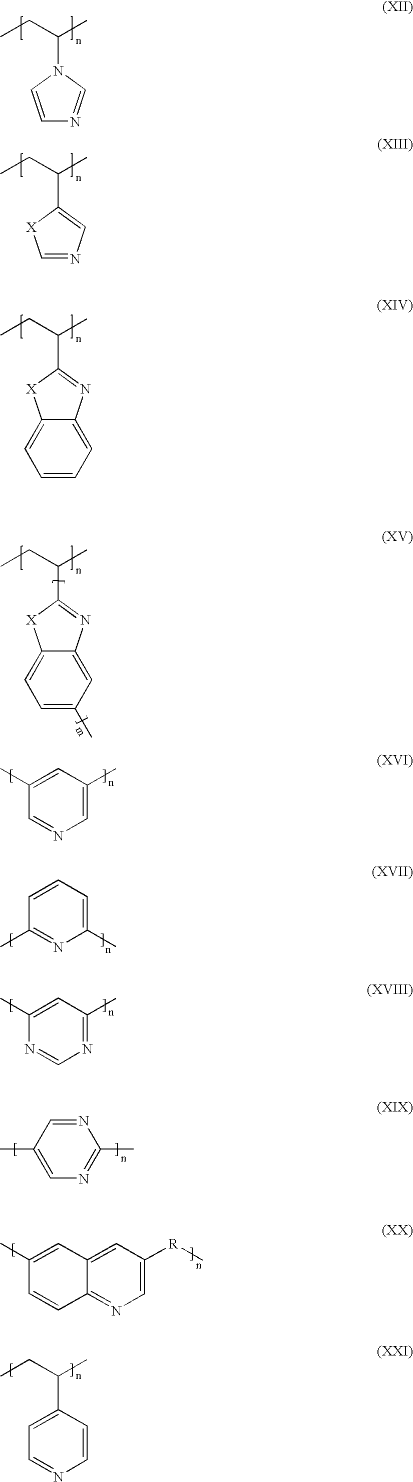 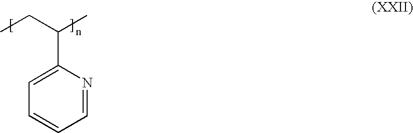
where
the radicals Ar are identical or different and are each a tetravalent aromatic or heteroaromatic group which can be monocyclic or polycyclic,
the radicals Ar¹ are identical or different and are each a divalent aromatic or heteroaromatic group which can be monocyclic or polycyclic,
the radicals Ar² are identical or different and are each a divalent or trivalent aromatic or heteroaromatic group which can be monocyclic or polycyclic,
the radicals Ar³ are identical or different and are each a trivalent aromatic or heteroaromatic group which can be monocyclic or polycyclic,
the radicals Ar⁴ are identical or different and are each a trivalent aromatic or heteroaromatic group which can be monocyclic or polycyclic,
the radicals Ar⁵ are identical or different and are each a tetravalent aromatic or heteroaromatic group which can be monocyclic or polycyclic,
the radicals Ar⁶ are identical or different and are each a divalent aromatic or heteroaromatic group which can be monocyclic or polycyclic,
the radicals Ar⁷ are identical or different and are each a divalent aromatic or heteroaromatic group which can be monocyclic or polycyclic,
the radicals Ar⁸ are identical or different and are each a trivalent aromatic or heteroaromatic group which can be monocyclic or polycyclic,
the radicals Ar⁹ are identical or different and are each a divalent or trivalent or tetravalent aromatic or heteroaromatic group which can be monocyclic or polycyclic,
the radicals Ar¹⁰ are identical or different and are each a divalent or trivalent aromatic or heteroaromatic group which can be monocyclic or polycyclic,
the radicals Ar¹¹ are identical or different and are each a divalent aromatic or heteroaromatic group which can be monocyclic or polycyclic,
the radicals X are identical or different and are each oxygen, sulphur or an amino group bearing a hydrogen atom, a group having 1-20 carbon atoms, preferably a branched or unbranched alkyl or alkoxy group, or an aryl group as further radical, the radicals R are identical or different and are each hydrogen, an alkyl group or an aromatic group and
n, m are each an integer greater than or equal to 10, preferably greater than or equal to 100.

Aromatic or heteroaromatic groups which are preferred according to the invention are derived from benzene, naphthalene, biphenyl, diphenyl ether, diphenylmethane, diphenyldimethylmethane, bisphenon, diphenyl sulphone, thiophene, furan, pyrrole, thiazole, oxazole, imidazole, isothiazole, isoxazole, pyrazole, 1,3,4-oxadiazole, 2,5-diphenyl-1,3,4-oxadiazole, 1,3,4-thiadiazole, 1,3,4-triazole, 2,5-diphenyl-1,3,4-triazole, 1,2,5-triphenyl-1,3,4-triazole, 1,2,4-oxadiazole, 1,2,4-thiadiazole, 1,2,4-triazole, 1,2,3-triazole, 1,2,3,4-tetrazole, benzo[b]thiophene, benzo[b]furan, indole, benzo[c]thiophene, benzo[c]furan, isoindole, benzoxazole, benzothiazole, benzimidazole, benzisoxazole, benzisothiazole, benzopyrazole, benzothiadiazole, benzotriazole, dibenzofuran, dibenzothiophene, carbazole, pyridine, bipyridine, pyrazine, pyrazole, pyrimidine, pyridazine, 1,3,5-triazine, 1,2,4-triazine, 1,2,4,5-triazine, tetrazine, quinoline, isoquinoline, quinoxaline, quinazoline, cinnoline, 1,8-naphthyridine, 1,5-naphthyridine, 1,6-naphthyridine, 1,7-naphthyridine, phthalazine, pyridopyrimidine, purine, pteridine or quinolizine, 4H-quinolizine, diphenyl ether, anthracene, benzopyrrole, benzooxathiadiazole, benzooxadiazole, benzopyridine, benzopyrazine, benzopyrazidine, benzopyrimidine, benzotriazine, indolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, which may also be substituted.

Ar¹, Ar⁴, Ar⁶, Ar⁷, Ar⁸, Ar⁹, Ar¹⁰, Ar¹¹ can have any substitution pattern; in the case of phenylene, Ar¹, Ar⁴, Ar⁶, Ar⁷, Ar⁸, Ar⁹, Ar¹⁰, Ar¹¹ can, for example, be ortho-, meta- and para-phenylene. Particularly preferred groups are derived from benzene and biphenyls, which may also be substituted.

Preferred alkyl groups are short-chain alkyl groups having from 1 to 4 carbon atoms, e.g. methyl, ethyl, n- or i-propyl and t-butyl groups.

Preferred aromatic groups are phenyl or naphthyl groups. The alkyl groups and the aromatic groups may be substituted.

Preferred substituents are halogen atoms such as fluorine, amino groups, hydroxy groups or short-chain alkyl groups such as methyl or ethyl groups.

Preference is given to polyazoles having recurring units of the formula (I) in which the radicals X within a recurring unit are identical.

The polyazoles can in principle also have a different recurring units, for example recurring units which differ in their radical X. However, it preferably has only identical radicals X in a recurring unit.

In a further embodiment of the present invention, the polymer comprising recurring azole units is a copolymer or a blend containing at least two units of the formulae (I) to (XXII) which differ from one another. The polymers can be block copolymers (diblock, triblock), random copolymers, periodic copolymers and/or alternating polymers.

The number of recurring azole units in the polymer is preferably an integer greater than or equal to 10. Particularly preferred polymers contain at least 100 recurring azole units.

For the purposes of the present invention, polymers comprising recurring benzimidazole units are preferred. Some examples of the extremely advantageous polymers comprising recurring benzimidazole units are those having the following formulae: 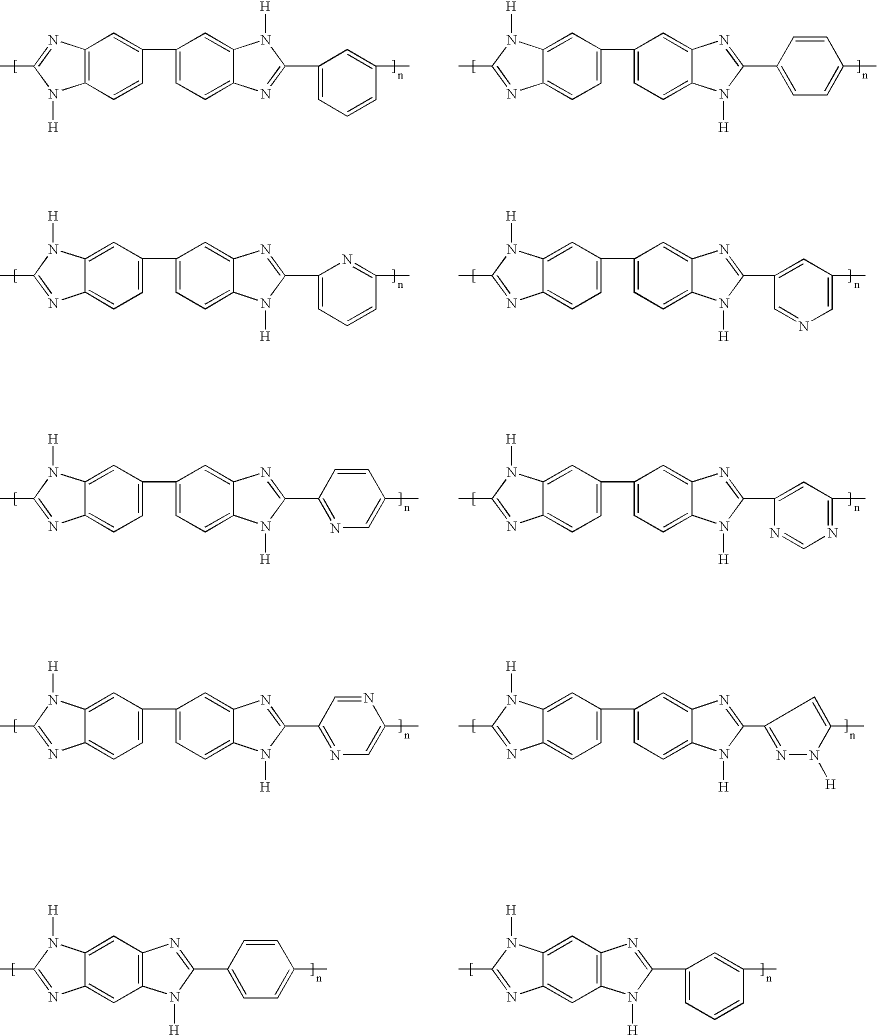 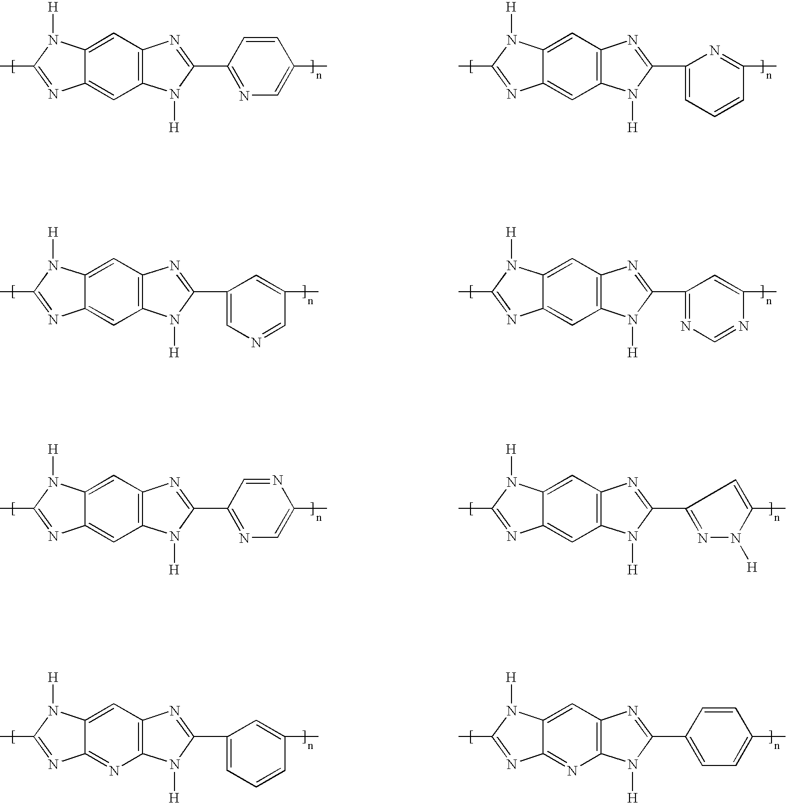 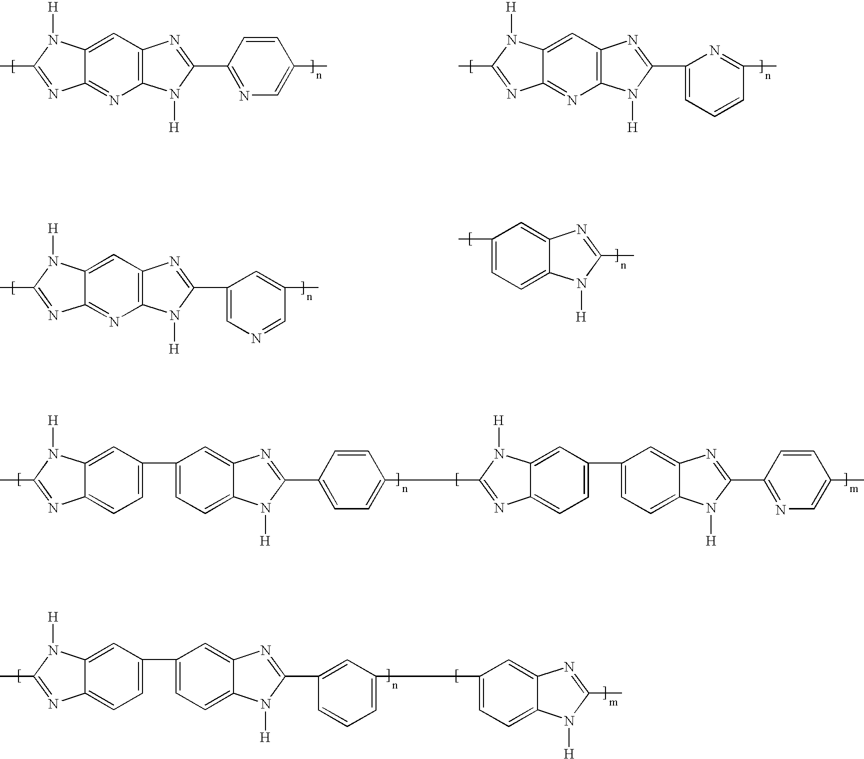
where n and m are each an integer greater than or equal to 10, preferably greater than or equal to 100.

The polyazoles used in step A), in particular the polybenzimidazoles, have a high molecular weight. Measured as intrinsic viscosity, this is preferably at least 0.2 dl/g, in particular from 0.7 to 10 dl/g, particularly preferably from 0.8 to 5 dl/g.

Further preferred polyazole polymers are polyimidazoles, polybenzothiazoles, polybenzoxazoles, polytriazoles, polyoxadiazoles, polythiadiazoles, polypyrazoles, polyquinoxalines, poly(pyridines), poly(pyrimidines) and poly(tetrazapyrenes).

Particular preference is given to Celazole from Celanese, in particular one in the case of which the polymer described in the German patent application no. 10129458.1 which has been worked up by sieving is used.

In addition, preference is given to polyazoles which have been obtained by the methods described in the German patent application no.10117687.2.

The preferred polymers include polysulphones, in particular polysulphone having aromatic and/or heteroaromatic groups in the main chain. According to a particular aspect of the present invention, preferred polysulphones and polyether sulphones have a melt volume rate MVR 300/21.6 of less than or equal to 40 cm³/10 min, in particular less than or equal to 30 cm³/10 min and particularly preferably less than or equal to 20 cm³/10 min, measured in accordance with ISO 1133. Here, polysulphones having a Vicat softening temperature VST/A/50 of from 180° C. to 230° C. are preferred. In another preferred embodiment of the present invention, the number average molecular weight of the polysulphones is greater than 30 000 g/mol.

The polymers based on polysulphone encompass, in particular, polymers which comprise recurring units which have linking sulphone groups and correspond to the general formulae A, B, C, D, E, F and/or G:
—O—R—SO₂—R— (A)
—O—R—SO₂—R—O—R— (B)
—O—R—SO₂—R—O—R—R— (C)

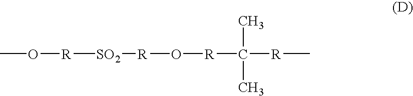

—O—R—SO₂—R—R—SO₂—R— (E)
—O—R—SO₂—R—R—SO₂—R—O—R—SO₂—] (F)
O—R—SO₂—RSO₂—R—R (G),
where the radicals R are identical or different and are each, independently of one another, an aromatic or heteroaromatic group, with these radicals having been described in detail above. They include, in particular, 1,2-phenylene, 1,3-phenylene, 1,4-phenylene, 4,4′-biphenyl, pyridine, quinoline, naphthalene, phenanthrene.

Polysulphones preferred for the purposes of the present invention encompass homopolymers and copolymers, for example random copolymers. Particularly preferred polysulphones comprise recurring units of the formulae H to N: 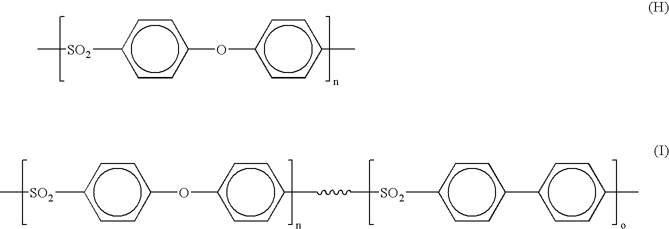
where n>o 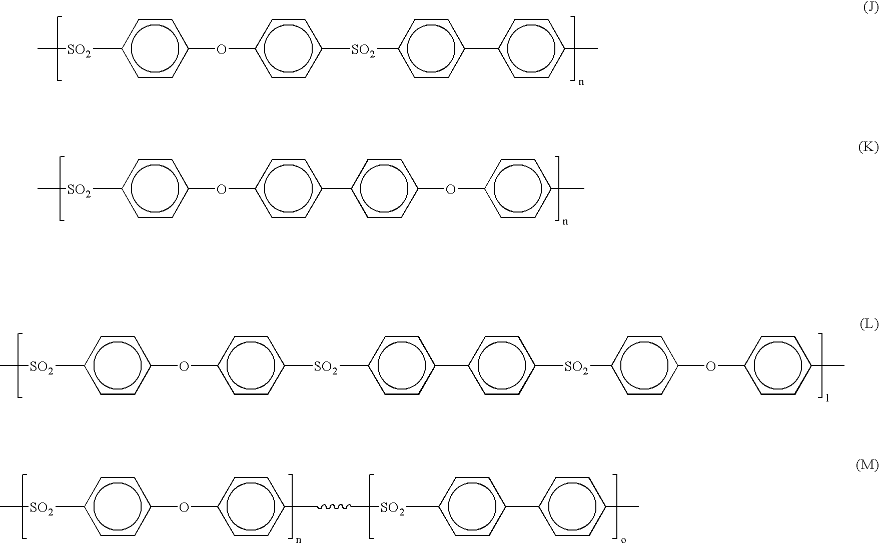
where n<o

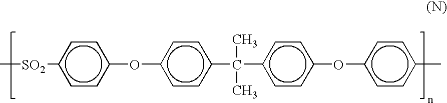

The above-described polysulphones are commercially available under the trade names ®Victrex 200 P, ®Victrex 720 P, ®Ultrason E, ®Ultrason S, ®Mindel, ®Radel A, ®Radel R, ®Victrex HTA, ®Astrel and ®Udel.

In addition, polyether ketones, polyether ketone ketones, polyether ether ketones, polyether ether ketone ketones and polyaryl ketones are particularly preferred. These high-performance polymers are known per se and are commercially available under the trade names Victrex® PEEK™, ®Hostatec, ®Kadel.

The abovementioned polymers can be used individually or as a mixture (blend). Preference is given, in particular, to blends comprising polyazoles and/or polysulphones. The use of blends enables the mechanical properties to be improved and the materials costs to be reduced.

The polymer membrane of the invention can additionally contain further additions of fillers and/or auxiliaries.

To improve the use properties further, fillers, in particular proton-conducting fillers, and additional acids can additionally be added to the membrane. They can be added, for example, in step A) and/or step B). Furthermore, these additives can also be added after the polymerization in step C) if they are in liquid form.

Nonlimiting examples of proton-conducting fillers are
sulphates such as: CsHSO₄, Fe(SO₄)₂, (NH₄)₃H(SO₄)₂, LiHSO₄, NaHSO₄, KHSO₄, RbSO₄, LiN₂H₅SO₄, NH₄HSO₄,
phosphates such as Zr₃(PO₄)₄, Zr(HPO₄)₂, HZr₂(PO₄)₃, UO₂PO₄.3H₂O, H₈UO₂PO₄, Ce(HPO₄)₂, Ti(HPO₄)₂, KH₂PO₄, NaH₂PO₄, LiH₂PO₄, NH₄H₂PO₄, CsH₂PO₄, CaHPO₄, MgHPO₄, HSbP₂O₈, HSb₃P₂O₁₄, H₅Sb₅P₂O₂₀,
polyacids such as H₃PW₁₂O₄₀.nH₂O (n=21-29), H₃SiW₁₂O₄₀.nH₂O (n=21-29), HXWO₃, HSbWO₆, H₃PMo₁₂O₄₀, H₂Sb₄O₁l, HTaWO₆, HNbO₃, HTiNbO₅, HTiTaO₅, HSbTeO₆, H₅Ti₄O₉, HSbO₃, H₂MoO4
selenites and arsenides such as (NH₄)₃H(SeO₄)₂, UO₂AsO₄, (NH₄)₃H(SeO₄)₂, KH₂AsO₄, CS₃H(SeO₄)₂, Rb₃H(SeO₄)₂,
oxides such as Al₂O₃, Sb₂O₅, ThO₂, SnO₂, ZrO₂, MoO₃
silicates such as zeolites, zeolites(NH₄⁺), sheet silicates, framework silicates, H-natrolites, H-mordenites, NH₄-analcines, NH₄-sodalites, NH₄-gallates, H-montmorillonites
acids such as HClO₄, SbF₅
fillers such as carbides, in particular SiC, Si₃N₄, fibres, in particular glass fibres, glass powders and/or polymer fibres, preferably fibres based on polyazoles.

All these additives can be present in the proton-conducting polymer membrane in customary amounts, but the positive properties such as high productivity, long life and high mechanical stability of the membrane should not be impaired too much by addition of excessive amounts of additives. In general, the membrane after the polymerization in step C) comprises not more than 80% by weight, preferably not more than 50% by weight and particularly preferably not more than 20% by weight, of additives.

Furthermore, this membrane can also contain perfluorinated sulphonic acid additives (preferably 0.1-20% by weight, more preferably 0.2-15% by weight, very particularly preferably 0.2-10% by weight). These additives lead to an improvement in the power, in the vicinity of the cathode to an increase in oxygen solubility and oxygen diffusion and to a reduction in adsorption of phosphoric acid and phosphate on platinum. (Electrolyte additives for phosphoric acid fuel cells. Gang, Xiao; Hjuler, H. A.; Olsen, C.; Berg, R. W.; Bjerrum, N. J. Chem. Dep. A, Tech. Univ. Denmark, Lyngby, Den. J. Electrochem. Soc. (1993), 140(4), 896-902 and Perfluorosulphonimide as an additive in phosphoric acid fuel cell. Razaq, M.; Razaq, A.; Yeager, E.; DesMarteau, Darryl D.; Singh, S. Case Cent. Electrochem. Sci., Case West. Reserve Univ., Cleveland, Ohio, USA. J. Electrochem. Soc. (1989), 136(2), 385-90.)

Nonlimiting examples of persulphonated additives are:
trifluoromethanesulphonic acid, potassium trifluoromethanesulphonate, sodium trifluoromethanesulphonate, lithium trifluoromethanesulphonate, ammonium trifluormethanesulphonate, potassium perfluorohexanesulphonate, sodium perfluorohexanesulphonate, lithium perfluorohexanesulphonate, ammonium perfluorohexanesulphonate, perfluorohexanesulphonic acid, potassium nonafluorobutanesulphonate, sodium nonafluorobutanesulphonate, lithium nonafluorobutanesulphonate, ammonium nonafluorobutanesulphonate, cesium nonafluorobutanesulphonate, triethylammonium perfluorohexanesulphonate and perfluorosulphonimide.

Vinyl-containing phosphonic acids are known to those skilled in the art. These are compounds which have at least one carbon-carbon double bond and at least one phosphonic acid group. The two carbon atoms which form the carbon-carbon double bond preferably have at least two, preferably three, bonds to groups which lead to low stearic hindrance of the double bond. Such groups include, inter alia, hydrogen atoms and halogen atoms, in particular fluorine atoms. For the purposes of the present invention, the polyvinylphosphonic acid is obtained from the polymerization product which is obtained by polymerization of the vinyl-containing phosphonic acid either alone or with further monomers and/or crosslinkers.

The vinyl-containing sulphonic acid can have one, two, three or more carbon-carbon double bonds. Furthermore, the vinyl-containing sulphonic acid can contain one, two or three or more sulphonic acid groups.

In general, the vinyl-containing sulphonic acid contains from 2 to 20, preferably from 2 to 10, carbon atoms.

The vinyl-containing sulphonic acid used in step A) is preferably a compound of the formula 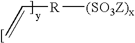
where
R is a bond, a C1-C15-alkyl group, C1-C15-alkoxy group, ethylenoxy group or C5-C20-aryl or heteroaryl group, with the above radicals being able to be in turn substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals being able to be in turn substituted by halogen, —OH, —CN, and
x is 1, 2, 3, 4, 5, 6, 7, 8, 9 or 10,
y is 1, 2, 3, 4, 5, 6, 7, 8, 9 or 10,
   and/or the formula 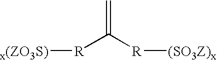
   where
R is a bond, a C1-C15-alkyl group, C1-C15-alkoxy group, ethylenoxy group or C5-C20-aryl or heteroaryl group, with the above radicals being able to be in turn substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals being able to be in turn substituted by halogen, —OH, —CN, and
x is 1, 2, 3, 4, 5, 6, 7, 8, 9 or 10,
   and/or the formula 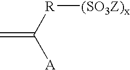
   where
A is a group of the formula COOR², CN, CONR²₂, OR² and/or R², where R² is hydrogen, a C1-C15-alkyl group, C1-C15-alkoxy group, ethylenoxy group or C5-C20-aryl or heteroaryl group, with the above radicals being able to be in turn subtituted by halogen, —OH, COOZ, —CN, NZ₂,
R is a bond, a divalent C1-C15-alkylene group, divalent C1-C15-alkylenoxy group, for example ethylenoxy group, or divalent C5-C20-aryl or heteroaryl group, with the above radicals being able to be in turn substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals being able to be in turn substituted by halogen, —OH, —CN, and
x is 1, 2, 3, 4, 5, 6, 7, 8, 9 or 10.

Preferred vinyl-containing sulphonic acids include, inter alia, alkenes bearing sulphonic acid groups, e.g. ethenesulphonic acid, propenesulphonic acid, butenesulphonic acid; acrylic acid and/or methacrylic acid compounds bearing sulphonic acid groups, for example 2-sulphomethylacrylic acid, 2-sulphomethylmethacrylic acid, 2-sulphomethylacrylamide and 2-sulphomethylmethacrylamide.

Particular preference is given to using commercial vinylsulphonic acid (ethenesulphonic acid), as is obtainable, for example, from Aldrich or Clariant GmbH. A preferred vinylsulphonic acid has a purity of greater than 70%, in particular 90% and particularly preferably greater than 97%.

The vinyl-containing sulphonic acids can also be used in the form of derivatives which can subsequently be converted into the acid, with the conversion into the acid also being able to be carried out in the polymerized state. These derivatives include, in particular, the salts, esters, amides and halides of vinyl-containing sulphonic acids.

The mixture prepared in step A) preferably comprises at least 1% by weight, in particular at least 5% by weight and particularly preferably at least 20% by weight, based on the total weight, of vinyl-containing sulphonic acid. According to a particular aspect of the present invention, the mixture prepared in step A) comprises not more than 60% by weight of polymer, in particular not more than 50% by weight of polymer and particularly preferably not more than 30% by weight, based on the total weight, of polymers.

In a particular embodiment of the present-invention, the mixture from step A) comprises vinyl-containing phosphonic acids. The addition of vinyl-containing phosphonic acid. surprisingly enables the high-temperature properties of the membrane to be improved. Even when a relatively small amount of these phosphonic acids is used, a membrane according to the invention can be operated for a short time even without moistening without the membrane being destroyed by this. If the proportion of vinyl-containing phosphonic acid is increased, the performance increases with increasing temperature, and this performance is also achieved without moistening.

The polyvinylphosphonic acid present in the membrane, which can also be crosslinked via reactive groups, forms an interpenetrating network with the high-temperature-stable polymer. The leaching of the electrolyte by means of product water formed, or in the case of a DMFC by the aqueous fuel, is therefore reduced significantly. A polymer electrolyte membrane according to the invention has a very low methanol permeability and is particularly suitable for use in a DMFC. Long-term operation of a fuel cell using many fuels such as hydrogen, natural gas, petroleum spirit, methanol or biomass is therefore possible. Here, the, membranes make a particularly high activity of these fuels possible. At high temperatures, the methanol oxidation can be carried out with high activity in this way. In a particular embodiment, these membranes are suitable for operation in a gaseous DMFC, in particular at temperatures in the range from 100 to 200° C.

The ability to operate the cell at temperatures above 100° C. greatly reduces the sensitivity of the Pt catalyst to gas impurities, in particular CO. CO is formed as by-product in the reforming of the hydrogen-rich gas from carbon-containing compounds such as natural gas, methanol or petroleum spirit or as intermediate in the direct oxidation of methanol. The CO content of the fuel at temperatures above 120° C. can typically be greater than 5000 ppm without the catalytic activity of the Pt catalyst being drastically reduced. However, at temperatures in the range 150-200° C., 10 000 ppm or more of CO can be tolerated (N. J. Bjerrum et. al. Journal of Applied Electrochemistry, 2001, 31, 773-779). This leads to considerable simplifications of the upstream reforming process and thus to cost reductions for the overall fuel cell system.

A membrane according to the invention having a high phosphonic acid content displays a good conductivity over a wide temperature range, and this conductivity is achieved even without additional moistening. Furthermore, a fuel cell which is equipped with a membrane according to the invention can also be operated with moistening at low temperatures, for example at 5° C., if the sulphonic acid content is relatively high.

Vinyl-containing phosphonic acids are known to those skilled in the art. They are compounds which contain at least one carbon-carbon double bond and at least one phosphonic acid group. The two carbon atoms which form the carbon-carbon double bond preferably have at least two, preferably three, bonds to groups which lead to low stearic hindrance of the double bond. These groups include, inter alia, hydrogen atoms and halogen atoms, in particular fluorine atoms. In the context of the present invention, the polyvinylsulphonic acid is obtained from the polymerization product obtained by polymerization of the vinyl-containing phosphonic acid either alone or with further monomers and/or crosslinkers.

The vinyl-containing phosphonic acid can have one, two, three or more carbon-carbon double bonds. Furthermore, the vinyl-containing phosphonic acid can contain one, two, three or more phosphonic acid groups.

In general, the vinyl-containing phosphonic acid has from 2 to 20, preferably from 2 to 10, carbon atoms.

The vinyl-containing phosphonic acid used in step A) is preferably a compound of the formula 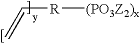
where
R is a bond, a C1-C15-alkyl group, C1-C15-alkoxy group, ethylenoxy group or C5-C20-aryl or heteroaryl group, with the above radicals being able to be in turn substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals being able to be in turn substituted by halogen, —OH, —CN, and
x is 1, 2, 3, 4, 5, 6, 7, 8, 9 or 10,
y is 1, 2, 3, 4, 5, 6, 7, 8, 9 or 10,
   and/or the formula 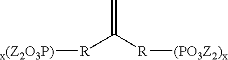
   where
R is a bond, a C1-C15-alkyl group, C1-C15-alkoxy group, ethylenoxy group or C5-C20-aryl or heteroaryl group, with the above radicals being able to be in turn substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals being able to be in turn substituted by halogen, —OH, —CN, and
x is 1, 2, 3, 4, 5, 6, 7, 8, 9 or 10,
   and/or the formula 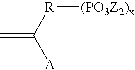
   where
A is a group of the formula COOR², CN, CONR²₂, OR² and/or R², where R² is hydrogen, a C1-C15-alkyl group, C1-C15-alkoxy group, ethylenoxy group or C5-C20-aryl or heteroaryl group, with the above radicals being able to be in turn subtituted by halogen, —OH, COOZ, —CN, NZ₂,
R is a bond, a divalent C1-C15-alkylene group, divalent C1-C15-alkylenoxy group, for example ethylenoxy group, or divalent C5-C20-aryl or heteroaryl group, with the above radicals being able to be in turn substituted by halogen, —OH, COOZ, —CN, NZ₂,
the radicals Z are each, independently of one another, hydrogen, a C1-C15-alkyl group, C1-C15-alkoxy group, ethylenoxy group or C5-C20-aryl or heteroaryl group, with the above radicals being able to be in turn substituted by halogen, —OH, —CN, and
x is 1, 2, 3, 4, 5, 6, 7, 8, 9 or 10.

Preferred vinyl-containing phosphonic acids include, inter alia, alkenes bearing phosphonic acid groups, e.g. ethenephosphonic acid, propenephosphonic acid, butenephosphonic acid; acrylic acid and/or methacrylic acid compounds having phosphonic acid groups, for example 2-phosphonomethylacrylic acid, 2-phosphonomethylmethacrylic acid, 2-phosphonomethylacrylamide and 2-phosphonomethylmethacrylamide.

Particular preference is given to using commercial vinylphosphonic acid (ethene-phosphonic acid), as is obtainable, for example, from Aldrich or Clariant GmbH. A preferred vinylphosphonic acid has a purity of greater than 70%, in particular 90% and particularly preferably greater than 97%.

The vinyl-containing phosphonic acids can also be used in the form of derivatives which can subsequently be converted into the acid, with the conversion to the acid also being able to be carried out in the polymerized state. These derivatives include, in particular, the salts, esters, amides and halides of the vinyl-containing phosphonic acids.

The use of vinyl-containing phosphonic acid is optional. The mixture prepared in step A) preferably comprises at least 20% by weight, in particular at least 30% by weight and particularly preferably at least 50% by weight, based on the total weight of the mixture, of vinyl-containing phosphonic acid.

The mixture prepared in step A) can additionally contain further organic and/or inorganic solvents. Organic solvents include, in particular, polar aprotic solvents such as dimethyl sulphoxide (DMSO), esters such as ethyl acetate, and polar protic solvents such as alcohols such as ethanol, propanol, isopropanol and/or butanol. Inorganic solvents include, in particular, water, phosphoric acid and polyphosphoric acid.

These can have a positive influence on the processability. In particular, the addition of the organic solvent can improve the solubility of the polymer. The content of vinyl-containing sulphonic acid in such solutions is generally at least 5% by weight, preferably at least 10% by weight, particularly preferably in the range from 10 to 97% by weight. The content of vinyl-containing phosphonic acid in such solutions is preferably at least 5% by weight, more preferably at least 10% by weight, particularly preferably in the range from 10 to 97% by weight.

The weight ratio of vinyl-containing phosphonic acid to vinyl-containing sulphonic acid can vary within a wide range. The ratio of vinyl-containing phosphonic acid to vinyl-containing sulphonic acid is preferably in the range from 1:100 to 99:1, in particular in the range from 1:10 to 10:1. At a ratio of greater than or equal to 1:1, in particular greater than or equal to 3:1, particularly preferably greater than or equal to 5:1, the membrane can also be operated at temperatures of greater than 100° C. without moistening.

In a further embodiment of the invention, the mixture comprising vinyl-containing sulphonic acid contains further monomers capable of effecting crosslinking. These are, in particular, compounds having at least 2 carbon-carbon double bonds. Preference is given to dienes, trienes, tetraenes, di(methylacrylates), tri(methylacrylates), tetra(methylacrylates), diacrylates, triacrylates, tetraacrylates.

Particular preference is given to dienes, trienes, tetraenes of the formula 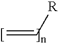
di(methylacrylates), tri(methylacrylates), tetra(methylacrylates) of the formula 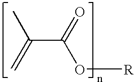
diacrylates, triacrylates, tetraacrylates of the formula 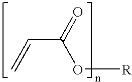
where
R is a C1-C15-alkyl group, C5-C20-aryl or heteroaryl group, NR′, —SO₂, PR′, Si(R′)₂, with the above radicals being able to be in turn substituted, the radicals R′ are each, independently of one another, hydrogen, a C1-C15-alkyl group, C1-C15-alkoxy group, C5-C20-aryl or heteroaryl group and
n is at least 2.

The substituents of the above radical R are preferably halogen, hydroxyl, carboxy, carboxyl, carboxyl esters, nitriles, amines, silyl, siloxane radicals.

Particularly preferred crosslinkers are allyl methacrylate, ethylene glycol dimethacrylate, diethylene glycol dimethacrylate, triethylene glycol dimethacrylate, tetraethylene and polyethylene glycol dimethacrylate, 1,3-butanediol dimethacrylate, glyceryl dimethacrylate, diurethane dimethacrylate, trimethylolpropane trimethacrylate, epoxyacrylates, for example ebacryl, N′,N-methylenebisacrylarmide, carbinol, butadiene, isoprene, chloroprene, divinylbenzene and/or bisphenol A dimethylacrylate. These compounds are commercially available, for example from Sartomer Company Exton, Pa., under the designations CN-120, CN104 and CN-980.

The use of crosslinkers is optional, and if these compounds are employed they are usually used in an amount of from 0.05 to 30% by weight, preferably from 0.1 to 20% by weight, particularly preferably from 1 to 10% by weight, based on the weight of vinyl-containing sulphonic acid and any vinyl-containing phosphonic acid.

The mixture of polymers produced in step A) can be a solution, with dispersed or suspended polymer being able to be additionally present in this mixture.

The formulation of the flat structure in step B) is carried out by means of methods known per se (casting, spraying, doctor blade coating, extrusion) which are known from the prior art for the production of polymer films. Accordingly, the mixture is suitable for forming a flat structure. The mixture can accordingly be a solution or a suspension, with the proportion of sparingly soluble constituents being restricted to amounts which allow the formation of flat structures. Suitable supports are all supports which are inert under the conditions. The supports include, in particular, films of polyethylene terephthalate (PET), polytetrafluoroethylene (PTFE), polyhexafluoropropylene, copolymer of PTFE with hexafluoropropylene, polyimides, polyphenylene sulphides (PPS) and polypropylene (PP).

To adjust the viscosity, the mixture can, if appropriate, be admixed with water and/or a volatile organic solvent. In this way, the viscosity can be set to the desired value and the formation of the membrane can be made easier.

The thickness of the flat structure is generally from 15 to 2000 μm, preferably from 30 to 1500 μm, in particular from 50 to 1200 μm, without this implying a restriction.

The polymerization of the vinyl-containing sulphonic acid and, if desired, vinyl-containing phosphonic acid in step C) preferably occurs by a free-radical mechanism. Free-radical formation can be effected thermally, photochemically, chemically and/or electrochemically.

For example, an initiator solution containing at least one substance capable of forming free-radicals can be added to the mixture from step A). Furthermore, an initiator solution can be applied to the flat structure formed in B). This can be achieved by means of methods known per se (e.g. spraying, dipping, etc.) which are known from the prior art.

Suitable free-radical formers include, inter alia, azo compounds, peroxy compounds, persulphate compounds or azoamidines. Nonlimiting examples are dibenzoyl peroxide, dicumene peroxide, cumene hydroperoxide, diisopropyl peroxydicarbonate, bis(4-t-butylcyclohexyl) peroxydicarbonate, dipotassium persulphate, ammonium peroxodisulphate, 2,2′-azobis(2-methylpropionitrile) (AIBN), 2,2′-azobis-(isobutyroamidine) hydrochloride, benzopinacol, dibenzyl derivatives, methylethylene ketone peroxide, 1,1-azobiscyclohexanecarbonitrile, methyl ethyl ketone peroxide, acetylacetone peroxide, dilauryl peroxide, didecanoyl peroxide, tert.-butyl per-2-ethylhexanoate, ketone peroxide, methyl isobutyl ketone peroxide, cyclohexanone peroxide, dibenzoyl peroxide, tert-butyl peroxybenzoate, tert-butyl peroxyisopropylcarbonate, 2,5-bis(2-ethylhexanoylperoxy)-2,5-dimethylhexane, tert-butyl peroxy-2-ethylhexanoate, tert-butyl peroxy-3,5,5-tri methyl hexanoate, tert-butyl peroxyisobutyrate, tert-butyl peroxyacetate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate and also the free-radical formers obtainable from DuPont under the name ®Vazo, for example ®Vazo V50 and ®Vazo WS.

Furthermore, it is also possible to use free-radical formers which form free radicals on irradiation. Preferred compounds include, inter alia, α,α-diethoxyacetophenone (DEAP, Upjon Corp), n-butyl benzoin ether (®Trigonal-14, AKZO) and 2,2-dimethoxy-2-phenylacetophenone (®Irgacure 651) and 1-benzoylcyclohexanol (®Irgacure 184), bis(2,4,6-trimethylbenzoyl)phenylphosphine oxide (®Irgacure 819) and 1-[4-(2-hydroxyethoxy)phenyl]-2-hydroxy-2-phenylpropane-1-one (®Irgacure 2959), each of which are commercially available from Ciba Geigy Corp.

It is usual to use from 0.0001 to 5% by weight, in particular from 0.01 to 3% by weight, (based on the sum of vinyl-containing sulphonic acid and any vinyl-containing phosphonic acid) of free-radical formers. The amount of free-radical formers can be varied depending on the desired degree of polymerization.

The polymerization can also be effected by action of IR or NIR (IR=infrared, i.e. light having a wavelength of greater than 700 nm; NIR=near IR, i.e. light having a wavelength in the range from about 700 to 2000 nm or an energy in the range from about 0.6 to 1.75 eV).

The polymerization can also be effected by action of UV light having a wavelength of less than 400 nm. This polymerization method is known per se and is described, for example, in Hans Joerg Elias, Makromolekulare Chemie, 5th edition, volume 1, pp. 492-511; D. R. Arnold, N. C. Baird, J. R. Bolton, J. C. D. Brand, P. W. M Jacobs, P. de Mayo, W. R. Ware, Photochemistry—An Introduction, Academic Press, New York, and M. K. Mishra, Radical Photopolymerization of Vinyl Monomers, J. Macromol. Sci.-Revs. Macromol. Chem. Phys. C22(1982-1983)409.

The polymerization can also be achieved by action of β-rays, γ-rays and/or electron beams. In a particular embodiment of the present invention, a membrane is irradiated with a radiation dose in the range from 1 to 300 kGy, preferably from 3 to 200 kGy and very particularly preferably from 200 to 100 kGy.

The polymerization of the vinyl-containing sulphonic acid and any vinyl-containing phosphonic acid in step C) is preferably carried out at temperatures above room temperature (20° C.) and less than 200° C., in particular at temperatures in the range from 40° C. to 150° C., particularly preferably from 50° C. to 120° C. The polymerization is preferably carried out under atmospheric pressure, but can also be carried out under superatmospheric pressure. The polymerization leads to a hardening of the flat structure, with this hardening be able to be followed by microhardness measurement. The increase in hardness due to the polymerization is preferably at least 20%, based on the hardness of the flat structure obtained in step B).

In a particular embodiment of the present invention, the membranes have a high mechanical stability. This parameter is given by the hardness of the membrane determined by means of microhardness measurement in accordance with DIN 50539. For this purpose, a Vickers diamond is pressed into the membrane with the force gradually increasing to 3 mN over 20 s and the penetration depth is determined. The hardness at room temperature determined by this method is at least 0.01 N/mm², preferably at least 0.1 N/mm² and very particularly preferably at least 1 N/mm², without this implying a restriction. Subsequently, the force is kept constant at 3 mN for 5 s and the creep is calculated from the penetration depth. In the case of preferred membranes, the creep C_{HU} 0.003/20/5 under these conditions is less than 20%, preferably less than 10% and very particularly preferably less than 5%. The modulus YHU determined by means of microhardness measurement is at least 0.5 MPa, in particular at least 5 MPa and very particularly preferably at least 10 MPa, without this implying a restriction.

Depending on the desired degree of polymerization, the flat structure obtained by swelling of the polymer film and subsequent polymerization is a self-supporting membrane. The degree of polymerization is preferably at least 2, in particular at least 5, particularly preferably at least 30, repeating units, in particular at least 50 repeating units, very particularly preferably at least 100 repeating units. This degree of polymerization is given by the number average molecular weight Mn which can be determined by GPC methods. Owing to the problems encountered in isolating the polyvinylphosphonic acid present in the membrane without degradation, this value is determined on a sample obtained by polymerization of vinylphosphonic acid without solvent and without addition of polymer. Here, the proportion by weight of vinylphosphonic acid and of free-radical initiators is kept constant in comparison to the ratios after detachment of the membrane. The conversion achieved in a comparative polymerization is preferably greater than or equal to 20%, in particular greater than or equal to 40% and particularly preferably greater than or equal to 75%, based on the vinyl-containing phosphonic acid used.

The polymerization in step C) can lead to a decrease in the layer thickness. The thickness of the self-supporting membrane is preferably in the range from 15 to 1000 μm, more preferably from 20 to 500 μm, in particular from 30 to 250 μm.

The polymer membrane of the invention preferably comprises from 1 to 90% by weight of the polymer and from 99 to 0.5% by weight of polyvinylsulphonic acid. The polymer membrane of the invention more preferably comprises from 3 to 85% by weight of the polymer and from 70 to 1% by weight of polyvinylsulphonic acid, particularly preferably from 5 to 50% by weight of the polymer and from 50 to 5% by weight of polyvinylsulphonic acid, in each case based on the total weight of the polymer membrane. The proportion of polyvinylphosphonic acid is preferably in the range from 5 to 97% by weight, in particular in the range from 20 to 95% by weight, in each case based on the total weight of the polymer membrane. In addition, the polymer membrane of the invention can contain further fillers and/or auxiliaries.

Subsequent to the polymerization in step C), the membrane can be crosslinked thermally, photochemically, chemically and/or electrochemically on the surface. This hardening of the membrane surface brings about an additional improvement in the properties of the membrane.

According to a particular aspect, the membrane can be heated to a temperature of at least 150° C., preferably at least 200° C. and particularly preferably at least 250° C. Thermal crosslinking is preferably carried out in the presence of oxygen. The oxygen concentration in this process step is usually in the range from 5 to 50% by volume, preferably from 10 to 40% by volume, without this implying a restriction.

Crosslinking can also be effected by action of IR or NIR (IR=infrared, i.e. light having a wavelength of greater than 700 nm; NIR=near IR, i.e. light having a wavelength in the range from about 700 to 2000 nm or an energy in the range from about 0.6 to 1.75 eV) and/or UV light. A further method is irradiation with β-rays, γ-rays and/or electron beams. The radiation dose is preferably from 5 to 200 kGy, in particular from 10 to 100 kGy. Irradiation can be carried out in air or under inert gas. The use properties of the membrane, in particular its durability, are improved in this way.

Depending on the desired degree of crosslinking, the duration of the crosslinking reaction can vary within a wide range. In general, this reaction time is in the range from 1 second to 10 hours, preferably from 1 minute to 1 hour, without this implying a restriction.

The polymer membrane of the invention has improved materials properties compared to the doped polymer membranes known hitherto. If the membranes of the invention have a high proportion of polyvinylphosphonic acid, they display an intrinsic conductivity compared to known undoped polymer membranes.

The intrinsic conductivity of the membrane of the invention at temperatures of 80° C., if appropriate with moistening, is generally at least 0.1 mS/cm, preferably at least 1 mS/cm, in particular at least 2 mS/cm and particularly preferably at least 5 mS/cm.

At a proportion by weight of polyvinylphosphonic acid of greater than 10%, based on the total weight of the membrane, the membranes generally display a conductivity at temperatures of 160° C. of at least 1 mS/cm, preferably at least 3 mS/cm, in particular at least 5 mS/cm and particularly preferably at least 10 mS/cm. These values are achieved without moistening.

The specific conductivity is measured by impedance spectroscopy in a 4-pole arrangement in the potentiostatic mode using platinum electrodes (wire, 0.25 mm diameter). The distance between the power output electrodes is 2 cm. The spectrum obtained is evaluated by means of a simple model consisting of a parallel arrangement of an ohmic resistance and a capacitor. The specimen cross section of the membrane doped with phosphoric acid is measured immediately before installation of the specimen. To measure the temperature dependence, the measurement cell is brought to the desired temperature in an oven and the temperature is regulated by means of a Pt-100 resistance thermometer positioned in the immediate vicinity of the specimen. After the temperature has been reached, the specimen is kept at this temperature for 10 minutes prior to commencement of the measurement.

The crossover current density in operation using 0.5 M methanol solution and at 90° C. in a liquid direct methanol fuel cell is preferably less than 100 mA/cm², in particular less than 70 mA/cm², particularly preferably less than 50 mA/cm² and very particularly preferably less than 10 mA/cm². The crossover current density in operation using a 2 M methanol solution and at 160° C. in a gaseous direct methanol fuel cell is preferably less than 100 mA/cm², in particular less than 50 mA/cm², very particularly preferably less than 10 mA/cm².

To determine the crossover current density, the amount of carbon dioxide released at the cathode is measured by means of a CO₂ sensor. The crossover current density is calculated from the amount of CO₂ measured in this way, as described by P. Zelenay, S. C. Thomas, S. Gottesfeld in S. Gottesfeld, T. F. Fuller “Proton Conducting Membrane Fuel Cells II” ECS Proc. Vol. 98-27, pp. 300-308.

The present invention also provides a membrane-electrode unit comprising at least one polymer membrane according to the invention. The membrane-electrode unit displays high performance even at a low content of catalytically active substances such as platinum, ruthenium or palladium. Gas diffusion layers provided with a catalytically active layer can be used for this purpose.

The gas diffusion layer generally displays electron conductivity. Flat, electrically conductive and acid-resistant structures are usually used for this purpose. These include, for example, carbon fibre papers, graphitized carbon fibre papers, woven carbon fibre fabrics, graphitized woven carbon fibre fabrics and/or flat structures which have been made conductive by addition of carbon black.

The catalytically active layer contains a catalytically active substance. Such substances include, inter alia, noble metals, in particular platinum, palladium, rhodium, iridium and/or ruthenium. These substances can also be used in the form of alloys with one another. Furthermore, these substances can also be used in alloys with base metals such as Cr, Zr, Ni, Co and/or Ti. In addition, the oxides of the abovementioned noble metals and/or base metals can also be used. According to a particular aspect of the present invention, the catalytically active compounds are used in the form of particles which preferably have a size in the range from 1 to 1000 nm, in particular from 10 to 200 nm and preferably from 20 to 100 nm.

The catalytically active particles comprising the abovementioned substances can be used as metal powder, known as noble metal black, in particular platinum and/or platinum alloys. Such particles generally have a size in the range from 5 nm to 200 nm, preferably in the range from 10 nm to 100 nm.

Furthermore, the metals can also be used on a support material. This support preferably comprises carbon which can be used, in particular, in the form of carbon black, graphite or graphitized carbon black. The metal content of these supported particles, based on the total weight of the particles, is generally in the range from 1 to 80% by weight, preferably from 5 to 60% by weight and particularly preferably from 10 to 50% by weight, without this implying a restriction. The particle size of the support, in particular the size of the carbon particles, is preferably in the range from 20 to 100 nm, in particular from 30 to 60 nm. The size of the metal particles located thereon is preferably in the range from 1 to 20 nm, in particular from 1 to 10 nm and particularly preferably from 2 to 6 nm.

The sizes of the various particles represent means of the weight average and can be determined by transmission electron microscopy.

The catalytically active particles described above are generally commercially available.

Furthermore, the catalytically active layer may contain customary additives. These include, inter alia, fluoropolymers such as polytetrafluoroethylene (PTFE) and surface-active substances.

Surface-active substances include, in particular, ionic surfactants, for example fatty acid salts, in particular sodium laurate, potassium oleate; and alkylsulphonic acids, salts of alkylsulphonic acids, in particular sodium perfluorohexanesulphonate, lithium perfluorohexanesulphonate, ammonium perfluorohexanesulphonate, perfluorohexanesulphonic acid, potassium nonafluorobutanesulphonate, and also nonionic surfactants, in particular ethoxylated fatty alcohols and polyethylene glycols.

Particularly preferred additives are fluoropolymers, in particular tetrafluoroethylene polymers. In a particular embodiment of the present invention, the weight ratio of fluoropolymer to catalyst material comprising at least one noble metal and if desired, one or more support materials, is greater than 0.1, preferably in the range from 0.2 to 0.6.

In a particular embodiment of the present invention, the catalyst layer has a thickness in the range from 1 to 1000 μm, in particular from 5 to 500 μm, preferably from 10 to 300 μm. This value represents a mean which can be determined by measuring the layer thickness in the cross section of micrographs obtained using a scanning electron microscope (SEM).

In a particular embodiment of the present invention, the noble metal content of the catalyst layer is from 0.1 to 10.0 mg/cm², preferably from 0.3 to 6.0 mg/cm² and particularly preferably from 0.3 to 3.0 mg/cm². These values can be determined by elemental analysis of a sample of the layer.

A membrane-electrode unit can be produced, inter alia, by hot pressing. For this purpose the assembly of electrode, comprising gas diffusion layers provided with catalytically active layers, and a membrane is heated to a temperature in the range from 50° C. to 200° C. and pressed by means of a pressure of from 0.1 to 5 MPa. In general, a few seconds are sufficient to join the catalyst layer to the membrane. This time is preferably in the range from 1 second to 5 minutes, in particular from 5 seconds to 1 minute.

The present invention likewise provides a proton-conducting polymer membrane according to the invention coated with a catalyst layer.

To apply a catalyst layer to the membrane, various methods can be used. Thus, for example, it is possible to use a support which is provided with a coating comprising a catalyst in order to provide the membrane according to the invention with a catalyst layer.

Here, the membrane can be provided with a catalyst layer on one or both sides. If the membrane is provided with a catalyst layer on only one side, the opposite side of the membrane has to be joined by pressing to an electrode having a catalyst layer. If both sides of the membrane are to be provided with a catalyst layer, the following methods can also be employed in combinations in order to achieve an optimum result.

According to the invention, the catalyst layer can be applied by a process in which a catalyst suspension is used. Furthermore, it is also possible to use powders comprising the catalyst.

The catalyst suspension comprises a catalytically active substance. Such substances have been described in detail above in relation to the catalytically active layer.

Furthermore, the catalyst suspension can contain customary additives. These include, inter alia, fluoropolymers such as polytetrafluoroethylene (PTFE), thickeners, in particular water-soluble polymers such as cellulose derivatives, polyvinyl alcohol, polyethylene glycol, and surface-active substances which have been disclosed above in relation to the catalytically active layer.

Furthermore, the catalyst suspension can comprise constituents which are liquid at room temperature. These include, inter alia, organic solvents which may be polar or nonpolar, phosphoric acid, polyphosphoric acid and/or water. The catalyst suspension preferably contains from 1 to 99% by weight, in particular from 10 to 80% by weight of liquid constituents.

Polar, organic solvents include, in particular, alcohols such as ethanol, propanol, isopropanol and/or butanol.

Organic, nonpolar solvents include, inter alia, known thin layer diluents such as thin layer diluents 8470 from DuPont, which comprises turpentine oils.

Particularly preferred additives are fluoropolymers, in particular tetrafluoroethylene polymers. In a particular embodiment of the present invention, the weight ratio of fluoropolymer to catalyst material comprising at least one noble metal and, if desired, one or more support materials is greater than 0.1, preferably in the range from 0.2 to 0.6.

The catalyst suspension can be applied to the membrane according to the invention by customary methods. Depending on the viscosity of the suspension, which can also be in paste form, various methods by means of which the suspension can be applied are known. Suitable methods are processes for coating films, fabrics, textiles and/or papers, in particular spray processes and printing processes such as stencilling and screen printing processes, ink jet processes, roller application, in particular halftone roller application, slit nozzle application and doctor blade coating. The particular process employed and the viscosity of the catalyst suspension are dependent on the hardness of the membrane.

The viscosity can be influenced by the solids content, in particular the proportion of catalytically active particles, and the proportion of additives. The viscosity to be set depends on the application method used for the catalyst suspension, and the optimum values and their determination are well known to those skilled in the art.

Depending on the hardness of the membrane, the bond between catalyst and membrane can be improved by heating and/or pressing.

According to a particular aspect of the present invention, the catalyst layer is applied by a powder method. Here, a catalyst powder in which additional additives such as those disclosed above by way of example may be present is used.

To apply the catalyst powder, it is possible to use, inter alia, spray processes and screen processes. In the spray process, the powder mixture is sprayed onto the membrane by means of a nozzle, for example a slit nozzle. In general, the membrane provided with a catalyst layer is subsequently heated to improve the bond between catalyst and membrane. Heating can be carried out, for example, by means of a hot roller. Such methods and apparatuses for applying the powder are described, inter alia, in DE 195 09 748, DE 195 09 749 and DE 197 57 492.

In the screen process, the catalyst powder is applied to the membrane by means of a vibrating screen. An apparatus for applying a catalyst powder to a membrane is described in WO 00/26982. After application of the catalyst powder, the bond between catalyst and membrane can be improved by heating. Here, the membrane which has been provided with at least one catalyst layer can be heated to a temperature in the range from 50 to 200° C., in particular from 100 to 180° C.

In addition, the catalyst layer can be applied by a process in which a catalyst-containing coating is applied to a support and the catalyst-containing coating present on the support is subsequently transferred to the membrane of the invention. Such a process is described, for example, in WO 92/15121.

The support provided with a catalyst layer can, for example, be produced by preparing a catalyst suspension as described above. This catalyst suspension is subsequently applied to a support film, for example a polytetrafluoroethylene film. After application of the suspension, the volatile constituents are removed.

The transfer of the coating comprising a catalyst can be carried out, inter alia, by hot pressing. For this purpose, the assembly comprising a catalyst layer and a membrane and also a support film is heated to a temperature in the range from 50° C. to 200° C. and pressed under a pressure of from 0.1 to 5 MPa. In general, a few seconds are sufficient to join the catalyst layer to the membrane. This time is preferably in the range from 1 second to 5 minutes, in particular from 5 seconds to 1 minute.

In a particular embodiment of the present invention, the catalyst layer has a thickness in the range from 1 to 1000 μm, in particular from 5 to 500 μm, preferably from 10 to 300 μm. This value is a mean which can be determined by measuring the layer thickness in the cross section of micrographs obtained using a scanning electrode microscope (SEM).

In a particular embodiment of the present invention, the membrane provided with at least one catalyst layer comprises from 0.1 to 10.0 mg/cm², preferably from 0.3 to 6.0 mg/cm² and particularly preferably from 0.3 to 3.0 mg/cm². These values can be determined by elemental analysis of a sample of the layer.

After coating with a catalyst, the membrane obtained can be crosslinked thermally, photochemically, chemically and/or electrochemically. This hardening of the membrane effects an additional improvement in the properties of the membrane. For this purpose, the membrane can be heated to a temperature of at least 150° C., preferably at least 200° C. and particularly preferably at least 250° C. In a particular embodiment, crosslinking is carried out in the presence of oxygen. The oxygen concentration in this process step is usually in the range from 5 to 50% by volume, preferably from 10 to 40% by volume, without this implying a restriction.

Crosslinking can also be effected by action of IR or NIR (IR=infrared, i.e. light having a wavelength of greater than 700 nm; NIR=near IR, i.e. light having a wavelength in the range from about 700 to 2000 nm or an energy in the range from about 0.6 to 1.75 eV) and/or UV light. A further method is irradiation with β-rays, γ-rays and/or electron beams. The radiation dose is preferably from 5 to 200 kGy, in particular from 10 to 100 kGy. Irradiation can be carried out in air or under inert gas. The use properties of the membrane, in particular the durability, are improved in this way.

Depending on the desired degree of crosslinking, the duration of the crosslinking reaction can vary within a wide range. In general, this reaction time is in the range from 1 second to 10 hours, preferably from 1 minute to 1 hour, without this implying a restriction.

The catalyst-coated polymer membrane according to the invention has improved materials properties compared to the doped polymer membranes known hitherto. In particular, they display improved power compared to known doped polymer membranes. This is due, in particular, to better contact between membrane and catalyst.

To produce a membrane-electrode unit, the membrane of the invention can be joined to a gas diffusion layer. If the membrane is provided on both sides with a catalyst layer, the gas diffusion layer does not have to comprise a catalyst before pressing.

A membrane-electrode unit according to the invention displays a surprisingly high power density. In a particular embodiment, preferred membrane-electrode units achieve a current density of at least 0.1 A/cm², preferably 0.2 A/cm², particularly preferably 0.3 A/cm². This current density is measured in operation using pure hydrogen at the anode and air (about 20% by volume of oxygen, about 80% by volume of nitrogen) at the cathode at atmospheric pressure (1013 mbar absolute, with open cell outlet) and a cell voltage of 0.6 V. Particularly high temperatures in the range 150-200° C., preferably 160-180° C., in particular 170° C., can be used here.

The power densities indicated above can also be achieved at a low stoichiometry of the combustion gases on both sides. According to a particular aspect of the present invention, the stoichiometry is less than or equal to 2, preferably less than or equal to 1.5, very particularly preferably less than or equal to 1.2.

In a particular embodiment of the present invention, the catalyst layer has a low noble metal content. The noble metal content of a preferred catalyst layer on a membrane according to the invention is preferably not more than 2 mg/cm², in particular not more than 1 mg/cm², very particularly preferably not more than 0.5 mg/cm². According to a particular aspect of the present invention, one side of a membrane has a higher metal content than the opposite of the membrane. The metal content on one side is preferably at least twice the metal content on the opposite side.

In one variant of the present invention, membrane formation can be effected directly on the electrode instead of on a support. The treatment in step C) can be correspondingly shortened as a result or the amount of initiator solution can be reduced, since the membrane no longer has to be self-supporting. The present invention also provides such a membrane and an electrode coated with such a polymer membrane according to the invention.

Furthermore, it is also possible to carry out the polymerization of the vinyl-containing phosphonic acid in the laminated membrane-electrode unit. For this purpose, the solution is applied to the electrode and brought into contact with the second electrode, which may likewise be coated, and pressed. The polymerization is subsequently carried out as described above in the laminated membrane-electrode unit.

The coating has a thickness of from 2 to 500 μm, preferably from 5 to 300 μm, in particular from 10 to 200 μm. This allows use in micro-fuel cells, in particular in DM micro-fuel cells.

Such a coated electrode can be installed in a membrane-electrode unit which may, if appropriate, comprise at least one polymer membrane according to the invention.

In a further variant, a catalytically active layer can be applied to the membrane of the invention and this can be joined to a gas diffusion layer. For this purpose, a membrane is formed by means of the steps A) to C) and the catalyst is applied. In one variant, the catalyst can be applied before or together with the initiator solution. These structures are also provided by the present invention.

In addition, the formation of the membrane in steps A), B) and C) can also be carried out on a support or a support film on which the catalyst is already present. After removal of the support or the support film, the catalyst is located on the membrane according to the invention. These structures are also provided by the present invention.

The present invention likewise provides a membrane-electrode unit comprising at least one polymer-membrane according to the invention, if appropriate in combination with a further polymer membrane based on polyazoles or a polymer blend membrane.

Possible application areas of the polymer membranes of the invention encompass; inter alia, use in fuel cells, in electrolysis, in capacitors and in battery systems. Owing to their property profile, the polymer membranes are preferably used in fuel cells.

### EXPERIMENTAL EXAMPLES

### Example 1

Preparation of Vinylsulphonic Acid

A column having a diameter of 5.5 cm is charged with an ion-exchange resin consisting of crosslinked sulphonated polystyrene of the type Dowex 50W-X4 obtained from Aldrich to a height of 20 cm. 100 ml of a 25% strength aqueous solution of sodium vinylsulphonate (0.19 mol) are subsequently allowed to run through the column, and 80-90 ml (0.16 mol) of vinylsulphonic acid are collected. The solution volume is subsequently reduced on a rotary evaporator so that the concentration of vinylsulphonic acid is 30% by weight.

### Examples 2-5

100 g of a polybenzimidazole polymer having an intrinsic viscosity of 1.0 dl/g are treated in 250 ml of an 89% strength phosphoric acid at 160° C. for 4 hours. The excess acid is subsequently removed by filtration through a suction filter and the solid is washed 3 times with water. The polymer obtained in this way is subsequently neutralized twice with 100 ml of a 10% strength ammonium hydroxide (NH₄OH) and subsequently treated twice with distilled water. The polymer is subsequently treated at 160° C. for 1 hour so that the residue moisture content is 8%.

500 g of vinylphosphonic acid (97%) obtainable from Clariant are then added to 28 g of the PBI polymer which has been pretreated in this way. With gentle stirring, a homogeneous solution is formed after 4 hours at 150° C.

150 g of the solution prepared in this way are taken and stirred slowly at 125° C. in a beaker having a ground glass flange. 4.6 g of the aqueous vinylsulphonic acid solution prepared as described in Example 1 are very slowly added dropwise to this solution. A membrane which is not self-supporting is produced from this solution by applying it to a polyethylene terephthalate support by doctor blade coating.

This membrane which is not self-supporting is subsequently treated by means of an electron beam at a radiation dose of 33-200 kGy. The membrane which has been irradiated with 198 kGy becomes brittle. The conductivity of the other membranes obtained in this way is determined by means of impedance spectroscopy and the mechanical properties are determined by means of microhardness measurement. The mechanical properties (modulus of elasticity, hardness HU and creep Cr) were determined by means of microhardness measurement. For this purpose, a Vickers diamond is pressed into the membrane with the force gradually increasing to 3 mN over 20 s and the penetration depth is determined. Subsequently, the force is kept constant at 3 mN for 5 s and the creep is calculated from the penetration depth. The properties of these membranes are summarized in Table 1.

TABLE 1
Properties of irradiated PBI-VSA/VPA membranes
produced from a PBI-VSA/VPA solution

| | | Con- | Con- | | | |
|---|---|---|---|---|---|---|
| | Radiation | ductivity | ductivity | Modulus of | | |
| | dose | @80° C. | @160° C. | elasticity | HU | Cr |
| | [kGy] | [mS/cm] | [mS/cm] | [MPa] | [MPa] | [%] |
| Ex. 2 | 33 | 8.0 | 13.2 | 23 | 1 | 4.4 |
| Ex. 3 | 66 | 3.8 | 8.1 | 29 | 1.6 | 4.1 |
| Ex. 4 | 99 | 2.1 | 4.5 | 33 | 1.6 | 3 |
| Ex. 5 | 198 | Brittle | Brittle | 193 | 7.4 | 4.2 |

1-19. (canceled)

20. A proton-conducting polymer membrane which is based on polyvinylsulphonic acid and is obtained by a process comprising the steps of:
a) mixing a polymer with a vinyl-containing sulphonic acid,
b) forming a flat structure using the mixture from step a) on a support,
c) polymerizing the vinyl-containing sulphonic acid present in the flat structure from step b),
characterized in that the membrane has an intrinsic conductivity of at least 0.001 S/cm.

21. The membrane of claim 20, characterized in that the polymer used in step a) is a high-temperature-stable polymer containing at least one nitrogen, oxygen, or sulphur atom in one repeating unit or in different repeating units.

22. The membrane of claim 20, characterized in that one or more polyazoles and/or polysulphones are used in step a).

23. The membrane of claim 20, characterized in that the mixture prepared in step a) contains compounds of the formula 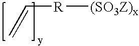
where
R is a bond, a C1-C15 alkyl group, C1-C15 alkoxy group, ethylenoxy group or C5-C20 aryl or heteroaryl group, with the above radications optionally substituted by halogen, —OH, COOZ, —CN, or NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN,
x is 1, 2, 3, 4, 5, 6, 7, 8, 9 or 10, and
y is 1, 2, 3, 4, 5, 6, 7, 8, 9 or 10, or
the formula 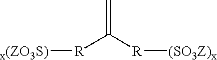
where
R is a bond, a C1-C15 alkyl group, C1-C15 alkoxy group, ethylenoxy group or C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN, and
x is 1, 2, 3, 4, 5, 6, 7, 8, 9 or 10, or
the formula 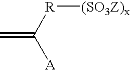
where
A is a group of the formula COOR², CN, CONR²₂, OR², or R², where R²is hydrogen, a C1-C15 alkyl group, C1-C15 alkoxy group, ethylenoxy group or C5-C20 aryl or heteroaryl group, with the above radicals optionally substituted by halogen, —OH, COOZ, —CN, NZ₂,
R is a bond, a divalent C1-C 15 alkylene group, divalent C1-C 15 alkylenoxy group, or a divalent C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN, and
x is 1, 2, 3, 4, 5, 6, 7, 8, 9 or 10.

24. The membrane of claim 20, characterized in that the mixture prepared in step a) comprises vinyl-containing phosphonic acid.

25. The membrane of claim 24, characterized in that the mixture prepared in step a) contains compounds of the formula 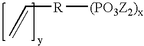
where
R is a bond, a C1-C15 alkyl group, C1-C15 alkoxy group, ethylenoxy group or C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN,
x is 1, 2, 3, 4, 5, 6, 7, 8, 9 or 10, and
y is 1, 2, 3, 4, 5, 6, 7, 8, 9 or 10, or
the formula 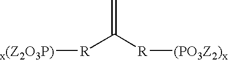
where
R is a bond, a C1-C15 alkyl group, C1-C15 alkoxy group, ethylenoxy group or C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN, and
x is 1, 2, 3, 4, 5, 6, 7, 8, 9 or 10, or
the formula 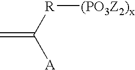
where
A is a group of the formula COOR², CN, CONR²₂, OR², or R², where R² is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, NZ₂,
R is a bond, a divalent C1-C15 alkylene group, divalent C1-C15 alkylenoxy group, or a divalent C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethyleonoxy group or C5-C20 aryl or heteroaryl group, with the above radicals optionally substituted by halogen, —OH, —CN, and
x is 1, 2, 3, 4, 5, 6, 7, 8, 9 or 10.

26. The membrane of claim 24, characterized in that the weight ratio of vinyl-containing phosphonic acid to vinyl-containing sulphonic acid is in the range from 1:100 to 99:1.

27. The membrane of claim 20, characterized in that the mixture prepared in step a) contains monomers capable of crosslinking.

28. The membrane of claim 20, characterized in that the polymerization in step c) is effected by means of a substance which is capable of forming free radicals.

29. The membrane of claim 20, characterized in that the polymerization in step c) is carried out by irradiation with IR light, NIR light, UV light, β-rays, γ-rays, or electron beams.

30. The membrane of claim 20, characterized in that the membrane comprises from 1 to 90% by weight of the polymer and from 99 to 0.5% by weight of polyvinylsulphonic acid.

31. The membrane of claim 20, characterized in that the membrane has a layer comprising a catalytically active component.

32. A mixture comprising:
a vinyl-containing sulphonic acid having the formula 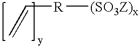
where
R is a bond, a C1-C15 alkyl group, C1-C15 alkoxy group, ethylenoxy group or C5-C20 aryl or heteroaryl group, with the above radications optionally substituted by halogen, —OH, COOZ, —CN, or NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN,
x is 1, 2, 3, 4, 5, 6, 7, 8, 9 or 10, and
y is 1, 2, 3, 4, 5, 6, 7, 8, 9 or 10, or
the formula 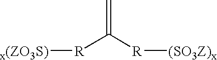
where
R is a bond, a C1-C15 alkyl group, C1-C15 alkoxy group, ethylenoxy group or C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN, and
x is 1, 2, 3, 4, 5, 6, 7, 8, 9 or 10, or
the formula 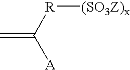
where
A is a group of the formula COOR², CN, CONR²₂, OR², or R², where R² is hydrogen, a C1-C15 alkyl group, C1-C15 alkoxy group, ethylenoxy group or C5-C20 aryl or heteroaryl group, with the above radicals optionally substituted by halogen, —OH, COOZ, —CN, NZ₂,
R is a bond, a divalent C1-C15 alkylene group, divalent C1-C15 alkylenoxy group, or a divalent C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN, and
x is 1, 2, 3, 4, 5, 6, 7, 8, 9 or 10; and
at least one polymer which has a solubility of at least 1% by weight in the vinyl-containing sulphonic acid.

33. The mixture of claim 32, characterized in that the polymer used contains at least one nitrogen, oxygen, or sulphur atom in one repeating unit or in different repeating units.

34. The mixture of claim 32, characterized in that it contains at least one monomer capable of crosslinking.

35. The mixture of claim 32, characterized in that it contains at least one initiator which is capable of forming free radicals.

36. The mixture of claim 32, characterized in that the mixture comprises at least one vinyl-containing phosphonic acid.

37. A membrane-electrode unit containing at least proton-conducting polymer membrane which is based on polyvinylsulphonic acid and is obtained by a process comprising the steps of:
a) mixing a polymer with a vinyl-containing sulphonic acid,
b) forming a flat structure using the mixture from step a) on a support,
c) polymerizing the vinyl-containing sulphonic acid present in the flat structure from step b),
characterized in that the membrane has an intrinsic conductivity of at least 0.001 S/cm.

38. The unit of claim 37, characterized in that the mixture prepared in step a) contains compounds of the formula 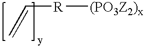
where
R is a bond, a C1-C15 alkyl group, C1-C15 alkoxy group, ethylenoxy group or C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN,
x is 1, 2, 3, 4, 5, 6, 7, 8, 9 or 10, and
y is 1, 2, 3, 4, 5, 6, 7, 8, 9 or 10, or
the formula 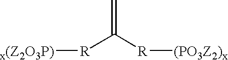
where
R is a bond, a C1-C15 alkyl group, C1-C15 alkoxy group, ethylenoxy group or C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN, and
x is 1, 2, 3, 4, 5, 6, 7, 8, 9 or 10, or
the formula 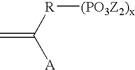
where
A is a group of the formula COOR², CN, CONR²₂, OR², or R², where R2 is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, NZ₂,
R is a bond, a divalent C1-C15 alkylene group, divalent C1-C15 alkylenoxy group, or a divalent C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethyleonoxy group or C5-C20 aryl or heteroaryl group, with the above radicals optionally substituted by halogen, —OH, —CN, and
x is 1, 2, 3, 4, 5, 6, 7, 8, 9 or 10.

39. The unit of claim 37, characterized in that the mixture prepared in step a) contains compounds of the formula 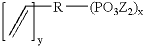
where
R is a bond, a C1-C15 alkyl group, C1-C15 alkoxy group, ethylenoxy group or C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN,
x is 1, 2, 3, 4, 5, 6, 7, 8, 9 or 10, and
y is 1, 2, 3, 4, 5, 6, 7, 8, 9 or 10, or
the formula 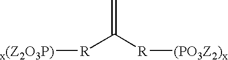
where
R is a bond, a C1-C15 alkyl group, C1-C15 alkoxy group, ethylenoxy group or C5-C20 aryl or heteroaryl group, with the above radicals optionally substituted by halogen, —OH, COOZ, —CN, NZ₂,
Z are each, independently of one another, hydrogen, a C1-C15 alkyl group, C1-C15 alkoxy group, ethylenoxy group or C5-C20 aryl or heteroaryl group, with the above radicals optionally substituted by halogen, —OH, —CN, and
x is 1, 2, 3, 4, 5, 6, 7, 8, 9 or 10, or
the formula 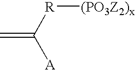
where
A is a group of the formula COOR², CN, CONR²₂, OR², or R², where R² is hydrogen, a C1-C15 alkyl group, C1-C15 alkoxy group, ethylenoxy group, or C5-C20 aryl or heteroaryl group, with the above radicals optionally substituted by halogen, —OH, COOZ, —CN, NZ₂,
R is a bond, a divalent C1-C15 alkylene group, divalent C1-C15 alkylenoxy group, or a divalent C5-C20 aryl or heteroaryl group with the above radicals optionally substituted by halogen, —OH, COOZ, —CN, NZ₂,
Z are each, independently of one another, hydrogen, a C1-C15 alkyl group, C1-C15 alkoxy group, ethyleonoxy group or C5-C20 aryl or heteroaryl group, with the above radicals optionally substituted by halogen, —OH, —CN, and
x is 1, 2, 3, 4, 5, 6, 7, 8, 9 or 10.

40. A fuel cell containing:
one or more membrane-electrode units containing at least one proton-conducting polymer membrane which is based on polyvinylsulphonic acid and is obtained by a process comprising the steps of:
a) mixing a polymer with a vinyl-containing sulphonic acid,
b) forming a flat structure using the mixture from step a) on a support,
c) polymerizing the vinyl-containing sulphonic acid present in the flat structure from step b),
characterized in that the membrane has an intrinsic conductivity of at least 0.001 S/cm, or one or more of the proton-conducting polymer membranes.
